(19) United States
(12) Patent Application Publication
(10) Pub. No.: US 2026/0318408 A1
(43) Pub. Date: Oct. 15, 2026

(54) SPRING DAMPER

(71) Applicant: Cummins Inc., Columbus, IN (US)

(72) Inventors: Silvia Grunwald, Steyr (AT); Johannes Bernoegger, Molln (AT); Alexander Schrenk, Steyr (AT); Bernhard Auer, Steyr (AT)

(21) Appl. No.: 19/462,613

(22) Filed: Jan. 28, 2026

Related U.S. Application Data
(60) Provisional application No. 63/750,473, filed on Jan. 28, 2025.

(51) Int. Cl. F16H 63/04

(52) U.S. Cl. CPC F16H 63/04

(57) ABSTRACT

A gear shift assembly is described. The gear shift assembly includes a shift actuator arranged to provide an input torque and a shift damping assembly. The shift damping assembly includes an input element connected to the shift actuator, and configured to rotate with the shift actuator, and an output element, and a linear shift actuator arranged to provide linear motion to a transmission for a gear shift operation. The output element is engaged with the linear shift actuator block to translate rotational motion of the shift actuator to linear motion of the linear shift actuator. The shift damping assembly also has a spring disposed between the input element and the output element. The shift damping assembly is arranged so as to permit relative rotation between the output element and the input element by deformation of the spring when the input torque is above a first torque threshold.

### CROSS REFERENCE TO RELATED APPLICATIONS

The present application claims the priority benefit of U.S. Provisional Patent Application No. 63/750,473, filed Jan. 28, 2025, attorney docket no. CI-24-0772-01-US, the complete disclosure of which is expressly incorporated by reference herein.

### FIELD OF THE DISCLOSURE

The present disclosure relates to a gear shift assembly and a shift damping assembly.

### BACKGROUND OF THE DISCLOSURE

Vehicles change gears by using a gear shift assembly to optimise the engine’s performance and efficiency across different driving conditions. Conventional gear shift assemblies have an actuator that is operated to move a shift fork to engage and disengage different gears within a gearbox. However, changing gears can result in shocks related to imperfect gear teeth alignment at shift, and a need for impact load absorption during gear engagement and disengagement. These problems can cause actuator stalling, inconsistent performance, and potential damage or increased wear to the actuator and other components.

A torsion spring mechanism is typically used to mitigate these problems by absorbing the impact loads and providing flexibility during gear shifting.

There is a need for an improved gear shift assembly.

### SUMMARY OF THE DISCLOSURE

A first aspect of the disclosure provides a gear shift assembly comprising one or more of the following features: a shift actuator arranged to provide an input torque; a shift damping assembly comprising: an input element connected to the shift actuator, and configured to rotate with the shift actuator; an output element, a linear shift actuator element arranged to provide linear motion to a transmission for a gear shift operation; wherein the output element is engaged with the linear shift actuator to translate rotational motion of the shift actuator to linear motion of the linear shift actuator; wherein the shift damping assembly comprises a spring, disposed between the input element and the output element, the spring having a central axis along a direction in which the spring is deformed, the shift damping assembly arranged so as to permit relative rotation between the output element and the input element by deformation of the spring in the direction of the central axis when the input torque is above a first torque threshold.

Optionally, the spring is deformed by compression or extension.

Optionally, the spring is a linear spring with a substantially linear central axis.

Optionally, the spring is an arc spring with a substantially arcuate central axis.

Optionally, the central axis of the spring is a coiling axis of the spring, and the central axis extends substantially perpendicular to a rotational axis of the shift actuator.

Optionally, the central axis of the spring is a coiling axis of the spring, and the central axis extends substantially circumferentially around a rotational axis of the shift actuator.

Optionally, the central axis of the spring extends in a plane that is perpendicular to a plane of the rotational axis of the shift actuator.

Optionally, wherein at least one of the input element and the output element comprises a recess at least partially receiving the spring.

Optionally, the spring is further configured to translate within at least one recess of the input element and the output element, to permit relative rotation between the input element and the output element when the demand torque is above the first torque threshold.

Optionally, the gear shift assembly further comprises a support plate, wherein the input element is positioned between the output element and the support plate.

Optionally, the spring is partially housed within the support plate, and optionally, the support plate has a recess to receive the spring.

Optionally, the input element is a first input element, the gear shift assembly further comprising a second input element connected to the actuator and configured to rotate with the shift actuator, wherein the output element is positioned between the first input element and the second input element.

Optionally, the linear spring is partially housed within the second input element, and optionally, the second input element has a recess to receive the spring.

Optionally, the input element further comprises at least one end stop, wherein the end stop is configured to limit relative rotation of the input element and the output element to prevent over-compression of the spring.

Optionally, the at least one end stop comprises a pin extending through an opening in at least one of the input element and the output element.

Optionally, the input element and the output element are configured to rotate about a common rotational axis.

Optionally, one of the input element and the output element is connected to the support plate, optionally connected with at least one connector pin extending through one of the input element and the output element, and through the support plate.

Optionally, the connector pin comprises the end stop.

Optionally, the spring comprises a dual spring assembly comprising a first spring and a second spring.

Optionally, the first spring and the second spring are disposed in a parallel arrangement to transfer torque between the input element and the output element.

Optionally, the second spring is positioned within the first spring, optionally wherein the second spring is arranged concentrically with the first spring.

Optionally, the linear spring further comprises a bearing element to allow slippage of the spring relative to the input element and the output element during rotation of the input element relative to the output element.

Optionally, the bearing element is provided as one or more caps at one or more ends of one or more of the spring or springs, wherein the caps are optionally plastic.

Optionally, the spring has a pre-load, wherein the pre-load is optionally a compressive pre-load.

Optionally, the pre-load is a linear pre-load.

A further aspect of the disclosure provides a shift damping assembly, comprising one or more of the following features: an input element configured to connect to and rotate with an actuator about an input axis, an output element configured to rotate relative to the input element about the input axis, wherein the output element comprises a linear slot configured for engagement with a linear shift actuator of a transmission, to translate rotational motion of the shift actuator to linear motion of the linear shift actuator element; wherein the shift damping assembly comprises a spring, disposed between the input element and the output element, the spring having a central axis along a direction in which the spring is deformed, the shift damping assembly arranged so as to permit relative rotation between the fork and the input element by deformation of the spring in the direction of the central axis.

Optionally, the spring is deformed by compression or extension.

Optionally, the spring is a linear spring with a substantially linear central axis.

Optionally, the spring is an arc spring with a substantially arcuate central axis.

It will be appreciated that the features of the invention described above can be combined in any combination or sub-set to realise related benefits of the disclosure and that not all of the listed features need be combined in order to realise benefits associated with a single feature.

### BRIEF DESCRIPTION OF THE DRAWINGS

Further features and advantages of examples embodying the present disclosure will be further described below, by way of example only, with reference to the accompanying drawings in which:

FIG. 1 is a cross-sectional view of an exemplary gearbox assembly;

FIG. 2 is a cross-sectional view of an exemplary shift damping assembly;

FIG. 3 is a perspective view of an exemplary input element;

FIG. 4 is a perspective view of an exemplary output element;

FIG. 5 is a perspective view of an exemplary linear spring;

FIG. 6 is a perspective view of an exemplary support plate;

FIG. 7A is a front view of the exemplary gear shift assembly in a neutral position;

FIG. 7B is a front view of the exemplary gear shift assembly in a fully rotated position in a first direction;

FIG. 7C is a front view of the exemplary gear shift assembly in a fully rotated position in a second direction; and

FIG. 8 is a front view of another exemplary gear shift assembly in a neutral position.

### DETAILED DESCRIPTION

While theoretically effective, torsion springs used in the prior art present significant manufacturing and assembly challenges. The high forces required for shifting, combined with small actuation angles, make it difficult to produce torsion springs with the necessary precision and consistency. Variations in the spring's characteristics can lead to inconsistent performance across different units, complicating reliable operation. Additionally, assembling torsion springs is complex and labour-intensive, further complicating production and maintenance.

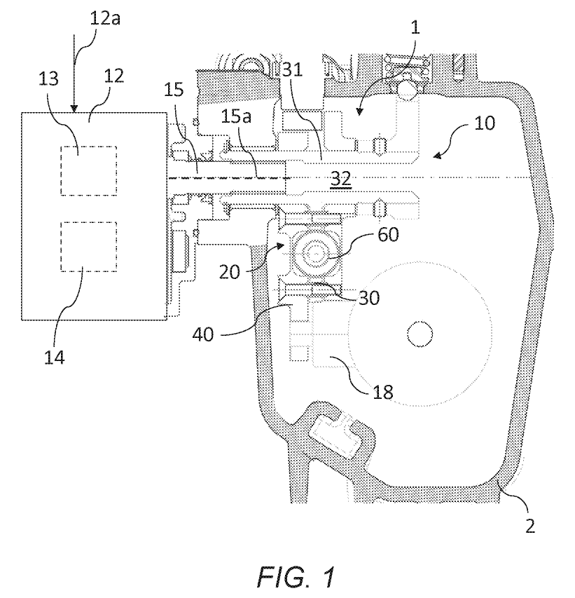

Examples of the present disclosure will be described with reference to the figures. FIG. 1 shows a cross-sectional view of a gearbox assembly 1 which can be assembled within a vehicle (not shown). The gearbox assembly 1 can form part of the transmission of the vehicle and can be housed within a bell housing 2. As shown, the bell housing 2 encloses and protects the gearbox assembly 1. The gearbox assembly 1 includes a gear shift assembly 10 that allows the drive train of the vehicle to change gears to adjust the vehicle’s speed and torque to match different driving conditions.

The gear shift assembly 10 includes a shift actuator 12. The shift actuator 12 is responsible for initiating a gear shift of the gearbox assembly 1 by generating the necessary torque. The shift actuator 12 is arranged to provide an input torque to the gear shift assembly 10 by generating rotational movement. The rotational movement of the shift actuator 12 is used to engage and disengage gears in a gearbox (not shown) of the assembly 1, by generating a gear shift motion via a shift damping assembly 20, which is described in more detail below.

In this example, the shift actuator 12 is an electric actuator with a motor 13 and a gear reduction system 14 (both shown schematically in FIG. 1). The motor 13 and gear reduction system 14 work together to create the necessary torque by producing rotational movement of the shift actuator 12. The gear reduction system 14 is configured to provide the required input torque from the shift actuator 12 by applying a reduction ratio to the output of the motor 13. For example, the input torque provided by the shift actuator 12 can be increased by applying a reduction ratio to the output of the motor 13, or vice versa. The amount of input torque generated by the shift actuator 12 may be controlled by a control input (indicated schematically by line 12a) provided to the shift actuator 12. For example, the control input may be an electrical signal, which may be received from a control system, or a mechanical signal, which may be received from a shift mechanism or other sub-system of the vehicle. The shift actuator 12 may therefore provide a varying amount of input torque depending on the control input received. The demand signal may also be a position or speed demand signal, instructing the shift actuator to shift in one direction or another through a predetermined rotational angle, and/or at a predetermined rotational speed. By using electric actuators in the shift actuator 12, the input torque generated by the shift actuator 12 can be conveniently and precisely controlled. However, the shift actuator 12 may be powered by any suitable arrangement, such as hydraulically (using fluid) or pneumatically (using air pressure) to generate rotational movement of the shift actuator 12.

The shift damping assembly 20 can be arranged to receive a rotational input from a rotational shift 12 actuator, and to provide a linear motion to a linear shift element 18 to provide a linear gear shift input to a gearbox or transmission. In the illustrated arrangement rotation of the shift actuator 12 can provide a rotational input or torque about axis 15a, which can be translated into a linear motion of linear actuation element 18. The axis 15a defines a rotational axis of the shift actuator 12. The shift actuator shaft 15 therefore rotates around the axis 15a in use, for example when actuated. The linear motion of linear actuation element 18 in the illustrated example of FIG. 1 is into and out of the page as seen in FIG. 1. The linear motion created can therefore be along in a direction of an axis that is perpendicular to the axis of rotation of the input rotation or torque.

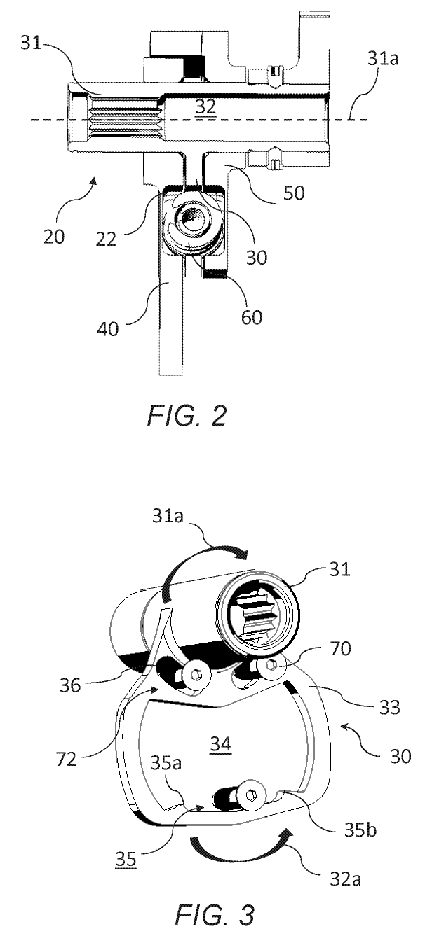

A cross-sectional view of the shift damping assembly 20 is shown in more detail in FIG. 2. The input torque generated by the shift actuator 12 is transmitted to the shift damping assembly 20 through the input element 30. The shift damping assembly 20 may include an input element 30 and an output element 40. The rotational motion (and input torque) produced by the shift actuator 12 can be transmitted to the shift damping assembly 20 via a shift actuator shaft 15. As shown more clearly in FIG. 1, the shift actuator shaft 15 may be received in the input element 30. The input element 30 is therefore connected to the shift actuator 12 so that the input element 30 rotates with the shift actuator 12. In this example, the input element 30 has a shaft 31 with a recess 32 that receives the shaft 15 of the shift actuator 12. The inner profile of the recess 32 may correspond to the outer profile of the shaft 15 to ensure that the input element 30 rotates with the shift actuator 12. The outer profile may be configured to transmit torque, such as by use of a non-circular interface profile, such as a spline interface.

FIG. 3 shows the input element 30 in more detail. As shown, the input element 30 is formed of the input element shaft 31 and an input element plate 33. The input element plate 33 extends perpendicularly to a central axis 31a of the input element shaft 31. The input element plate 33 is arranged to rotate with the input element shaft 31 as the input element shaft 31 rotates. Rotation of the input element shaft 31 (indicated by arrows 31a) therefore results in rotation of the input element plate 33 (indicated by arrows 32a). The input element plate 33 therefore rotates along the central axis 31a of the input element shaft 31. As shown in FIG. 1, as the input element shaft 31 receives the shift actuator shaft 15, the shift actuator shaft 15 also rotates along the same central axis 31a of the input element shaft 31. The central axis 31a of the input element shaft is therefore coincident with an input axis 15a of the shift actuator shaft 15 of the shift actuator 12.

The shape of the input element plate 33 may be changed depending on the overall arrangement or size of the shift damping assembly 20. In the example shown in FIG. 3, the input element plate 33 has generally trapezoidal shape. An input element recess 34 extends through the input element plate 33. The input element recess 34 extends through the entire thickness of the input element plate 33, i.e., the input element recess 34 is a through-hole.

The shape of the input element recess 34 may be changed depending on the overall arrangement or size of the shift damping assembly 20. In this example, the input element recess 34 has a generally “bow-tie” or “butterfly” shape. The input element recess 34 is symmetrical and the outer edges of the recess 34 form a shape that resembles an hour-glass shape. A further recessed portion 35 extends along one edge of the input element recess 34. The further recessed portion 35 has two vertices 35a, 35b that act as end stops for movement of the input element 30 (described in more detail below).

The input element plate 33 is connected to the input element shaft 31 at one end of the input element plate 33. The input element plate 33 and the input element shaft 31 may be formed as one unitary component (e.g. by casting) or may be formed as two separate components that are secured together by any suitable means.

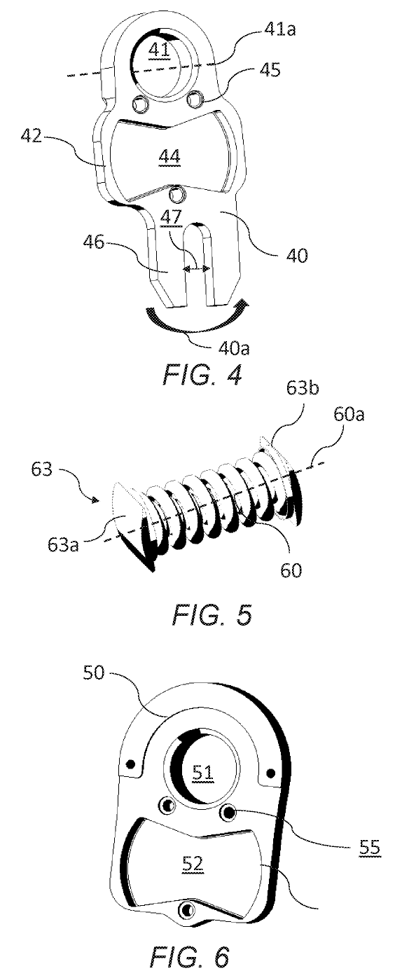

The input element 30 is connected to the output element 40, which is shown in more detail in FIG. 4, via a spring 63. In the example shown, the spring 63 is a linear spring. As with the input element 30, the shape of the output element 40 may be changed depending on the overall arrangement or size of the shift damping assembly 20. The output element 40 is formed of an output element plate 42 that includes an aperture 41, an output element recess 44, and two extensions 46 that form a linear slot 47 between the extensions 46.

The output element 40 is arranged to connect to a linear shift actuator element, which may be termed a linear shift actuator block 18, which also forms part of the shift damping assembly 20. The linear shift actuator block 18 forms part of the transmission of the gearbox assembly 1 and is used to select different gears within the gearbox assembly 1. When installed in a gearbox assembly, the linear slot 47 engages the linear shift actuator block 18 to linearly translate the linear actuator block 18 as the output element 40 rotates with the shift actuator 12. The output element 40 is therefore able to translate rotational motion of the shift actuator 12 to linear motion of the linear shift actuator element 18. One way of facilitating this is via the linear slot 47. However other means for converting rotational motion to linear motion could be envisaged, such as a connecting rod that is rotationally connected at either end to the output element and the linear shift actuator element, and the illustrated slot is just one example. The linear slot 47 is formed between the extensions 46 of the output element 40. The extensions 46 of the output element 40 are elongate protrusions that extend away from the output element recess 44. In the example shown in FIG. 4, the extensions 46 extend in a direction opposite the aperture 41. The extensions 46 are distanced from each other along the width of the output element 40. The extensions 46 form a “fork” of the output element. As the output element 40 rotates (shown schematically with arrow 40a in FIG. 4 and described in more detail below), the extensions 46 rotate and the linear shift actuator 18 is received in the recess 44, which causes linear movement of the linear shift actuator 18.

In the example shown in FIG. 4, the output element 40 is formed as a unitary component. However, in other examples, the aperture 41, output element recess 44, and/or the output element extensions 46 may be provided as separate parts that are connected together. The output element plate 42 extends perpendicularly with a central axis of the aperture 41a. The output element recess 44 is not a through hole. The output element recess 44 extends partially into the thickness of the output element plate 42 to form a recessed cavity. The shape of the output element recess 44 may be changed depending on the overall arrangement or size of the shift damping assembly 20. In this example, the output element recess 44 has a generally “bow-tie” or “butterfly” shape. The output element recess 44 is symmetrical and the outer edges of the recess 44 forms a shape that resembles an hour-glass shape.

As shown in FIG. 1, the output element 40 is arranged to be positioned adjacent to the input element 30. The shape and dimension of the output element recess 44 corresponds to the shape and size of the input element recess 34 so that they both at least overlap. Therefore, when the shift damping assembly 20 is assembled, the input element recess 34 and the output element recess 44 together form a receiving cavity 22. The receiving cavity 22 can define an area between and/or within one or both of the input element 30 and the output element 40 that receives a spring 60 (discussed in more detail below).

The output element 40 is rotatably connected to the input element 30. In this example, the output element aperture 41 is mounted to the input element 30 so that the output element 40 rotates about an axis common with the input element 30. The output element aperture 41 is a through-hole that extends through the output element plate 42. As shown more clearly in FIGS. 1 and 2, the input element shaft 31 is received in the aperture 41 of the output element plate 42. The output element 40 is therefore rotatable relative to the input element 30. Rotation of the input element shaft 31 therefore results in the transfer of a torque to the output element plate 42 (indicated by arrow 42a) via spring 60. In the example shown, the spring 60 is a linear spring 60. The output element plate 42 is therefore able to rotate about the input axis 15a of the shift actuator 12 (which corresponds to the central axis 31a of the input element shaft 31). In this arrangement, the output element 40 and the input element 30 therefore rotate along a common axis, i.e. the central axis 31a of the input element shaft 31.

The output element 40 is mechanically and rotatably connected to the input element 30 to ensure that the output element 40 can rotate relative to the input element 30. In the example shown in FIGS. 1-4, the output element 40 and the input element 30 have their rotational motion relative to one another limited by connection elements 70 that extend through elongate openings 36 in the input element 30 and are received in an opening in the output element plate 42.

A degree of relative rotation between the input element 30 and the output element 40 is desired. It may however be desirable to limit the extent of relative rotation between the input element 30 and the output element 40 that is possible. This can be achieved by having connection elements 70 which are fixedly attached to a first of the input element 30 and the output element 40, and which are arranged such that they are free to move relative to the second of the input element 30 and the output element 40, to a limited extent. The limited extent may be provided by one or more end stops provided in one or more apertures. Optional examples illustrated are, for example, end stops 35a and/or 35b, which can be provided in an aperture which is configured to receive the spring 60. Alternatively, one or more end stops may be provided in one or more apertures that may receiving the one or more connection elements 70 separately from the spring 60. One example is apertures 36 provided in the input element 30. By providing an arrangement which enables limited movement of the input element 30 relative to the output element 40, which may include one or more end stops, a mechanical limit to the relative rotation between the input element 30 and the output element 40 can be provided. This can protect the spring 60 from over-compression in the case of excessive torque in the system.

As shown in FIG. 4, the output element 40 includes apertures 45 that may be through holes that may extend through the output element plate 45. Similarly, the input element 30 includes apertures 36 that are through holes that extend through the input element plate 33. The apertures 45 in the output element 40 and the apertures 36 in the input element 30 are arranged to receive connection elements 70. The connection elements 70 extend through one or more or both of the input element plate 33 and the output element plate 42 to connect the input element 30 and the output element 40 together and to permit limited relative movement between the input element 30 and the output element 40. The connection elements 70 allow the input element 30 and the output element 40 to rotate relative to one another. Such rotation may be brought about by rotation of the shift actuator 12. This also ensures that the receiving cavity 22 is maintained with at least a minimal defined elongate length as the input element 30 and the output element 40 rotate relative to each other.

In this example, the connection elements 70 are pins that extend through the respective apertures 36,45 in the input element 30 and the output element 40. The connection elements 70 may be any suitable means to provide the desired limited rotation between the output element 40 and the input element 30, such as fasteners, bolts.

When a shift command is implemented by shift actuator 12, the linear motion of the shift actuator element 18 may be at least temporarily restricted, for example if gear teeth are not sufficiently aligned when the shift command is actioned. Therefore, there may be a period of time when a torque is applied by the shift actuator 12, but the linear shift actuator 18 is restricted from linear movement. The same may be true when shifting out of gear and there is a certain level of friction between gear teeth, or teeth of a dog clutch of the transmission, temporarily preventing the gear teeth from disengaging. In these kinds of circumstances, the output element 40 may be restricted from rotating at the same rate as the input element, or possibly from rotating at all, at least for a period. In the absence of a mechanism which can allow rotation of the shift actuator 12 when the movement of the output element 40 is restricted, this would cause the shift actuator 12 to become restricted from generating rotational movement with the motor 13 and gear reduction system 14. This restriction in movement of the shift actuator 12 can be undesirable as it may generate excess forces in the shift actuator 12, could, for example, because it to slip, damage the gear shift assembly 10, or otherwise may cause the motor to stall, which can also be undesirable.

When the shift actuator 12 becomes restricted, the damage to the gear shift assembly 10 can be minimised by permitting relative rotation between the output element 40 and the input element 30 once the input torque (generated by the shift actuator 12) exceeds a torque threshold. The torque threshold is typically above the normal operating torque of the shift actuator 12 and indicative of an obstruction to the typical operation of the gear shift assembly 10. The torque threshold may vary depending on the size and arrangement of the gearbox assembly 1.

The shift damping assembly 20 is therefore arranged to permit relative rotation between the input element 30 and the output element 40 when the input torque is above the torque threshold. The shift damping assembly 20 is therefore arranged to absorb impacts and/or peaks in torque or forces generated between the shift actuator 12 and the linear shift actuator block 18. The linear spring 60 is shown in more detail in FIGS. 2, 5 and 7A to 7C. The spring can be received in the shift damping assembly 20, so as rotate with the shift damping assembling, and may be disposed so as to rotate with rotatable components of the shift damping assembly. As shown, the linear spring 60 is disposed between the input element 30 and the output element 40 to permit relative rotation between the input element 30 and the output element 40. In this example, the linear spring 60 is at least partially received in the receiving cavity 22 that is formed by the input element recess 34 and the output element recess 44. The linear spring 60 can therefore be partially housed in the input element 30 and partially housed in the output element 40. In some examples, the linear spring 60 may only be housed in the input element 30 or only the output element 40. In this example, the linear spring 60 extends along the width of the input element recess 34 and the width of the output element recess 44. The linear spring 60 is therefore contained in the input element 30 and/or the output element 40. By being housed in this arrangement, the stability of the spring 60 is maintained. Furthermore, the spring 60 is provided in a compact packaging within the shift damping assembly 20. The spring 60 has a central axis 60a. In this example, the central axis 60a of the spring 60 is substantially linear, and extends longitudinally along the length of the linear spring 60. The central axis 60a therefore defines a coiling axis of the spring 60 and defines the direction that each coil of the spring 60 extends. The spring 60 is therefore coiled around the central axis 60a. The central axis 60a may be not in the same axis or not in the same plane as the rotational axis 15a of the shift actuator 12. The central axis 60a may be non-co-axial or non-parallel to the rotational axis 15a of the shift actuator 12. The central axis 60a may be in a plane substantially perpendicular to the rotational axis 15a of the shift actuator 12. When received in the receiving cavity 22, the longitudinal axis 60a of the linear spring 60 extends perpendicular with the input shaft axis 31a and the input axis 15a of the shift actuator 12.

The receiving cavity 22 may be defined by the perimeter of the input element recess 34 and the perimeter of the output element recess 44, and may act as a “window” that not only receives the linear spring 60, but also abuts against the linear spring 60 at least during operation of the shift damping assembly 20 to compress the spring 60. The linear spring 60 is therefore arranged within the receiving cavity 22 and is in compressive after contact with the perimeter of the output element recess 44 and/or the input element recess 34 during use.

The linear spring 60 is configured to compress in the direction of the central axis (i.e., along the central axis 60a of the spring 60). The spring 60 therefore deforms along an axial direction to absorb any torque variations that may arise from restrictions on the movement of the linear shift actuator 18 when the shift actuator 12 rotates. The spring 60 may deform by compression (where both ends of the spring 60 move closer to each other) or by extension (where both ends of the spring 60 are moved away from each other).

Optionally, the spring 60 is pre-tensioned with a linear pre-load. The linear pre-load is typically a compressive load but may also be tensile pre-load in cases where the mechanism is arranged to operate the spring intension rather than in compression. The linear spring compresses to smooth out input torque fluctuations from the shift actuator 12 and ultimately prevents the shift actuator 12 from stalling. This provides a more reliable and consistent performance of the gear shift assembly 10.

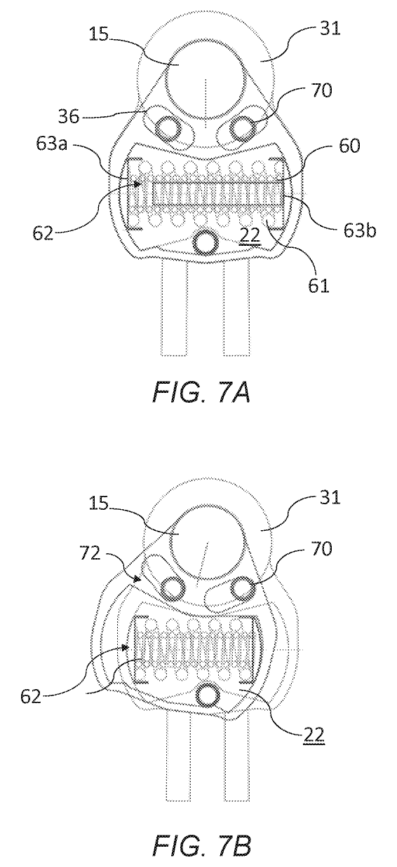

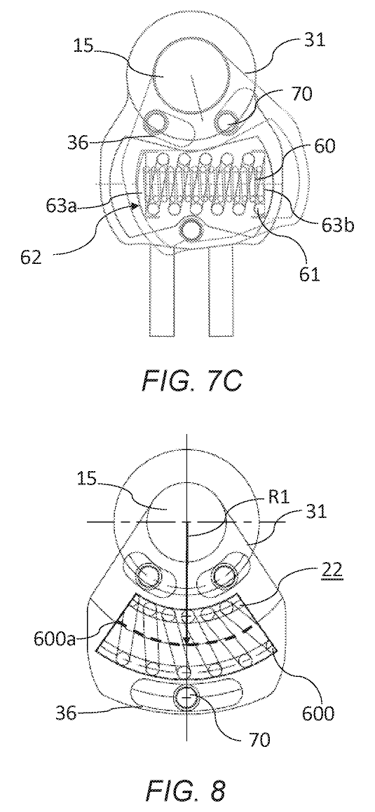

In the example shown in FIG. 2, only one linear spring 60 is housed within the receiving cavity 22. However, in other examples, there may be more than one linear spring 22 within the receiving cavity. By having more than one spring within the shift damping assembly 20, the available spring k-factor available within a set space can be improved. This allows the shift damping assembly 20 to absorb/react more torque than if only one spring 60 was used in the receiving cavity 22. The linear spring 60 may be a dual spring assembly 62 with a first spring 60 positioned parallel to a second spring 61 to transfer torque between the input element 30 and the output element 40. In other examples, such as the ones shown in FIGS. 7A-7C, the linear spring 60 is a dual spring assembly 62 and includes a first linear spring 60 housed inside a second linear spring 61. In this example, the first linear spring 60 is positioned concentrically with the second linear spring 61, but do not necessarily need to be concentric.

The linear spring 60 may be provided with bearing elements 63. As shown in FIG. 5, the bearing elements 63 can be provided at distal ends of the spring 60 and may allow the springs 60, 61 to translate vertically or horizontally relative to the input element 30 and the output element 40 during rotation of the input element 30 relative to the output element 40. This may occur when the spring 60 is smaller than the receiving area, and so may have space to translate. The spring 60 can therefore translate within the receiving area 22 when being compressed. This spring 60 will therefore continue to permit relative rotation between the output element 40 and the input element 30 until the end stop or stops, if present, are reached. The bearing elements 63 in this example are provided as caps 63a, 63b at an end of the spring 60. The caps 63a, 63b may only be provided at one end of the spring 60 or may be provided at both distal ends of the spring 60. The optional bearing elements 63 can therefore allow the springs 60, 61 to “slip” within the receiving cavity 22 during operation of the gear shift assembly 10. This not only protects the ends of the springs 60, 61 during use within the shift damping assembly 20, but also allows the springs 60, 61 to translate freely within the receiving cavity 22 as the output element 40 and input element 30 rotate. The caps 63a, 63b can be made from any suitable material to allow translation of the spring 60, such as plastic.

To prevent over-compression of the spring(s) 60, 61 the input element 30 has an end stop 72 that is configured to limit relative rotation of the input element 30 and the output element 40. In the example shown in FIG. 1, the connector pin 70 and the apertures 36 in the input element plate 33 act as end stops 72. As the input element 30 rotates, the connector pin 70 abuts against the end of the apertures 36 and prevents the input element 30 rotating any further relative to the output element 40. The connector pins 70 also prevent over rotation of the output element 40 the input element 30. Similarly, the connector pin 70 may also act as an end stop 72 by abutting against the vertices 35a, 35b in the additional recess 35 in the input element recess 34. This arrangement therefore protects the shift actuator 12.

The shift damping assembly 20 may further include a support element 50, which may be a support plate 50 as shown in FIG. 6. As with the input element 30 and the output element 40, the shape of the support element 50 may be changed depending on the overall arrangement or size of the shift damping assembly 20. The input element 30 is positioned between the output element 40 and the support element 50 in the shift damping assembly 20. The support element 50 has an aperture 51 and a support element recess 52. The aperture 51 of the support element 50 is arranged to connect the support element 50 to the shaft 31 of the input element 30. As shown more clearly in FIG. 2, the aperture 51 of the support element 50 receives the shaft 31 of the input element 30 so that the rotation of the input element 30 also causes rotation of the support element 50, via the spring 60 in a similar manner to that described above in relation to output element 40.

In the example shown in FIG. 6, the support element 50 is formed as a unitary component. The aperture 51 can be provided as a through-hole in the support element 50. The support element recess 52 may not be a through hole. The support element recess 52 can extend partially into the thickness of the support element 50 to form a recessed cavity. The shape of the support element recess 52 may be changed depending on the overall arrangement or size of the shift damping assembly 20. In this example, the support element recess 52 has a generally “bow-tie” or “butterfly” shape. The support element recess 52 is symmetrical and the outer edges of the recess 52 form a shape that resembles an hour-glass shape.

As shown in FIG. 1 and 2, the support element 50 may be arranged to be positioned adjacent to the input element 30, on an opposite side to the output element 40. The input element 30 can therefore be positioned between the support element 50 and the output element 40. The shape and dimension of the support element recess 52 may correspond to the shape and size of the input element recess 34 so that they at least overlap. Therefore, when the shift damping assembly 20 is assembled, the input element recess 34, the output element recess 44 and the support element recess 52 may together form the receiving cavity 22. In this arrangement, the receiving cavity 22 can be defined by the area between the input element 30, the output element 40, the support element 50. The linear spring 60 can also therefore be partially housed in the support element 50.

The support element 50 can also include several apertures 55 arranged to receive connection elements 70. The connection elements 70 extend through the apertures in the input element 30 and the support element 50, to connect the output element 40 and the support element 50. The connection elements 70 allow the output element 40 and the support element 50 to rotate together about the axis 31a. In other examples, the input element 30 may be connected to the support element 50 through connecting elements 70 and the output element may be received between the input element 30 the support the plate 50. When the connection element 70 is also used as an end stop 72, the rotation of the input element 30 is tied to the movement of the support element 50. The support element 50 and the input element 30 therefore rotate together under action of the shift actuator 12 when the end stop is reached.

The operation of the linear spring 60 when the demand torque exceeds a threshold is described in relation to FIG. 7A-7C. In the arrangement shown in these figures, the spring 60 is provided as a dual spring assembly 62 with a first spring 61 housed inside a second spring 60. The springs 60, 61 have bearing elements 63 at the ends of the springs 60, 61. In FIG. 7A, the output element 40, input element 30 and support plate 50 are in a neutral position, with the springs 60, 61 in a nominal state within the receiving cavity 22. In the nominal state, the spring or springs may be pre-compressed, to provide a threshold force which must be overcome before any relative rotation between the input element 30 and the output element 40 is induced. As shown, the connector pins 70 are positioned at a nominal position away from end stops, in this example in the centre, of the input element apertures 36.

In FIG. 7B, the input torque of the shift actuator 12 exceeds a threshold amount which is set by the pre-compression of the spring or springs. As shown, the input element 30 rotates relative to the output element 40, which causes the length available for the spring to occupy in the receiving area 22 to decrease as the input element 30 rotates relative to the output element 40. The linear springs 60, 61 are compressed in response to the rotation of the input element 30 relative to the output element 40. As the springs 60, 61 compress, the input element 30 is still able to rotate relative to the output element 40, thereby allowing the shift actuator 12 to still operate without stalling when the input torque exceeds a threshold. The input element 30 continues to rotate until the connector pins 70 abut against the end of the apertures 36 in the input element 30, thereby acting as end stops. The springs 60, 61 therefore compress to account for variations in torque from the shift actuator 12 above the threshold set by the pre-compression of the spring or springs.

Similarly, in FIG. 7C, shows the similar rotation as shown in FIG. 7C, but in the opposite direction. As shown, the springs 60, 61 operate in an identical (reversed) manner to permit relative rotation of the input element 30 to the output element 40.

FIG. 8 shows another exemplary arrangement of the shift damping assembly 20. Identical components with the shift damping assembly 20 are provided with identical reference numerals. In this arrangement, receiving cavity 22 is substantially arcuate to receive an arc spring 600. The arc spring 600 acts in a substantially identical manner to the linear spring 60 in that the arc spring 600 is arranged to abut against the receiving cavity 22 during the operation of the shift damping assembly 20 to compress the spring 600. The arc spring 600 is therefore arranged within the receiving cavity 22 and is in compressive after contact with the perimeter of the output element recess 44 and/or the input element recess 34 during use.

As shown, the arc spring 600 is substantially arcuate. The arc spring 600 is therefore curved along the length of the spring 600 and has a reference radius R1. In this example, the reference radius R1 of the arc spring 600 is defined from a centre point of the input axis 15a. The spring 600 has a central axis 600a. In this example, the central axis 600a is substantially arcuate and extends along the length of the spring 600. The central axis 600a defines a coiling axis of the spring 600 and defines the direction that each coil of the spring 600 extends. The spring 600 is therefore coiled around the central axis 600a. The central axis 600a may be not in the same plane as the rotational axis 15a of the shift actuator 12. The central axis 600a may be non-co-axial or non-parallel to the rotational axis 15a of the shift actuator 12. The central axis 600a may be in a plane substantially perpendicular to the rotational axis 15a of the shift actuator 12. The central axis 600a may extend substantially circumferentially around the rotational axis 15a of the shift actuator 12. The central axis 600a may extend substantially circumferentially in a plane that is substantially perpendicular to the rotational axis 15a of the shift actuator 12.

The spring 600 may be configured to compress in the direction of the central axis 600a. The spring 600 can therefore deform to absorb any torque variations that may arise from restrictions on the movement of the linear shift actuator 18 when the shift actuator 12 rotates. The spring 600 may deform by compression (where both ends of the spring 600 move closer to each other) or by extensions (where both ends of the spring 600 are moved away from each other). It will be understood that the arc spring 600 may be curved in any suitable manner that allows the arc spring 600 to compress along a curved axis 600a. The curved design of the arc spring 600 allows the spring 600 to distribute loads more event across the spring 600.

It will also be understood that the arc spring 600 may be arranged as a dual spring arrangement (not shown) in a similar manner to the linear spring 60. Similarly, the arc spring 600 may be pre-tensioned with a pre-load.

It will be understood that the arrangement shown in FIG. 8 operates in a substantially identical manner to the arrangement shown in FIGS. 7A-7C, except in that the arc spring 600 deforms in an arcuate direction instead of deforming in a linear axial direction, as is the case with spring 60. In both examples, the spring 60 and the spring 600 deform in the direction of their respective central axis 60a, 600a. The arc spring 600 provides a compact arrangement of the spring 600 within the shift damping assembly 20. The shift damping assembly 20 can therefore operate in a smaller, more compact arrangement.

In the examples shown and described above, the shift damping assembly 20 is formed by connecting the shift actuator 12 to the input element 40, which in turn rotates the output element 40. However, it will be understood that the shift damping assembly 20 may work equally well if the gear shift mechanism 10 had an alternative arrangement with multiple input elements. For example, the shift damping assembly 20 may be arranged to have two input elements and an output element 40 between the first and second input element. The first and second input elements may be connected to the shift actuator 12, while the output element 40 is connected to the linear shift block 18. Similarly to the arrangement shown in FIG. 1, the linear spring 60 would therefore be housed in between the first and/or second input element and the output element 40 to allow relative rotation between the input element(s) and the output element 40.

The gear shift assembly and shift damping assembly described herein can be used in a wide array of vehicles, such as transmission cars, motorcycles, trucks and large commercial vehicles, agricultural machinery and heavy-duty vehicles, such as bulldozers and excavators. However, the assemblies described herein are particularly advantageous in larger vehicles (such as trucks or lorries) where smooth transition between gears is difficult due to the increased mass and inertia and resulting torques and forces resent in the vehicle transmissions. The described gear shift assembly and shift damping assembly therefore allows the transmission to shift gears while minimising the occurrence of stalling of the shift actuator, allowing greater control over torque transfer when shifting gears to avoid shocks, stalling or damage in the shift actuator.

Although the disclosure has been described above with reference to one or more preferred examples, it will be appreciated that various changes or modifications may be made without departing from the scope of the appended claims.

1. A gear shift assembly comprising:
a shift actuator arranged to provide an input torque; and
a shift damping assembly comprising:
an input element connected to the shift actuator, and configured to rotate with the shift actuator;
an output element, and
a linear shift actuator element arranged to provide linear motion to a transmission for a gear shift operation;
wherein the output element is engaged with the linear shift actuator element to translate rotational motion of the shift actuator to linear motion of the linear shift actuator element; and
wherein the shift damping assembly comprises a spring, disposed between the input element and the output element, the spring having a central axis along a direction in which the spring is deformed, the shift damping assembly arranged so as to permit relative rotation between the output element and the input element by deformation of the spring in the direction of the central axis when the input torque is above a first torque threshold.

2. The gear shift assembly according to claim 1, wherein the spring is partially housed within at least one of the input element and the output element.

3. The gear shift assembly according to claim 2, wherein at least one of the input element and the output element comprises a recess at least partially receiving the spring.

4. The gear shift assembly according to claim 3, wherein the spring is further configured to translate within at least one recess of the input element and the output element, to permit relative rotation between the input element and the output element when a demand torque is above the first torque threshold.

5. The gear shift assembly according to claim 1, further comprising a support plate, wherein the input element is positioned between the output element and the support plate.

6. The gear shift assembly according to claim 5, wherein the spring is partially housed within the support plate, and the support plate has a recess to receive the spring.

7. The gear shift assembly according to claim 1, wherein the input element is a first input element, the gear shift assembly further comprising a second input element connected to the shift actuator and configured to rotate with the shift actuator, wherein the output element is positioned between the first input element and the second input element.

8. The gear shift assembly according to claim 7, wherein the spring is partially housed within the second input element, and the second input element has a recess to receive the spring.

9. The gear shift assembly according to claim 1, wherein the input element further comprises at least one end stop, wherein the at least one end stop is configured to limit relative rotation of the input element and the output element to prevent over-compression of the spring.

10. The gear shift assembly according to claim 9, wherein the at least one end stop comprises a pin extending through an opening in at least one of the input element and the output element.

11. The gear shift assembly according to claim 1, wherein the input element and the output element are configured to rotate about a common rotational axis.

12. The gear shift assembly according to claim 11, wherein one of the input element and the output element is connected to the support plate, connected with at least one connector pin extending through one of the input element and the output element, and through the support plate.

13. The gear shift assembly according to claim 12, when dependent on claim 16, wherein the connector pin comprises the at least one end stop.

14. The gear shift assembly according to claim 1, wherein the spring comprises a dual spring assembly comprising a first spring and a second spring.

15. The gear shift assembly according to claim 14, wherein the first spring and the second spring are disposed in a parallel arrangement to transfer torque between the input element and the output element.

16. The gear shift assembly according to claim 14, wherein the second spring is positioned within the first spring, wherein the second spring is arranged concentrically with the first spring.

17. The gear shift assembly according to claim 1, wherein the spring further comprises a bearing element to allow slippage of the spring relative to the input element and the output element during rotation of the input element relative to the output element.

18. The gear shift assembly according to claim 17, wherein the bearing element is provided as one or more caps at one or more ends of one or more of the spring or springs, wherein the caps are plastic.

19. A shift damping assembly, comprising:
an input element configured to connect to and rotate with an actuator about an input axis, and
an output element configured to rotate relative to the input element about the input axis,
wherein the output element comprises a linear slot configured for engagement with a linear shift actuator of a transmission, to translate rotational motion of the linear shift actuator to linear motion of the linear shift actuator; and
wherein the shift damping assembly comprises a spring, disposed between the input element and the output element, the spring having a central axis along a direction in which the spring is deformed, the shift damping assembly arranged so as to permit relative rotation between a fork and the input element by deformation of the spring in the direction of the central axis.

20. The shift damping assembly according to claim 19, wherein the spring is a linear spring with a substantially linear central axis.
